(19) United States
(12) Patent Application Publication
(10) Pub. No.: US 2025/0062601 A1
(43) Pub. Date: Feb. 20, 2025

(54) AUTOMATIC DIRECTION SWITCHING PENDULUM-TYPE ROTARY DRIVE RATCHET FOR INDIRECT LIVE WIRE

(71) Applicants: DAEWON ELECTRIC CO.,LTD., Cheongju-si, Chungcheongbukdo (KR); DAEWON INDUSTRY COMPANY, Jeungpyeong-gun, Chungcheongbuk-do (KR)

(72) Inventor: Sae Won KWON, Jeungpyeong-gun, Chungcheongbuk-do (KR)

(21) Appl. No.: 18/725,822

(22) PCT Filed: Jan. 3, 2023
(86) PCT No.: PCT/KR2023/000112

§ 371 Date: Jul. 1, 2024

(30) Foreign Application Priority Data
Feb. 14, 2022 (KR) 10-2022-0018577

(51) Int. Cl. H02G 1/04; F16D 43/208

(52) U.S. Cl. CPC H02G 1/04; F16D 43/208

(57) ABSTRACT

Provided relates to a rotary drive ratchet used in a wire grip or tensioner and, more specifically, to an automatic direction switching pendulum-type rotary drive ratchet for an indirect live wire, which is configured to adjust, when winding or unwinding a wire grip or tensioner, the forward or backward rotation of a pendulum drive shaft by means of the operation of an automatic reversing pawl and a pendulum drive shaft operation plate in accordance with a reciprocating motion of a pendulum without the operation of a direction switching lever, so as to enable the forward or backward reversing rotation of the pendulum drive shaft to be automatically performed by means of operating a rotary lever using a stick for an indirect live wire without a separate rotational direction switching operation.

### TECHNICAL FIELD

The present invention relates to a rotary drive ratchet used in a wire grip or a tensioner, and more particularly, to an automatic direction switching pendulum-type rotary drive ratchet for an indirect live wire, configured to automatically adjust a rotation direction and to prevent reverse rotation by operating a rotary lever using a stick for the indirect live wire without a separate rotational direction switching operation.

### BACKGROUND ART

In general, live wire work refers to line work conducted in a state in which power transmission is continuously performed without a power outage on the line. Meanwhile, since the risk of safety incidents is very high during live wire work, live wire work is conducted by a trained worker with strict adherence to specific safety and insulation standards only when it is difficult to cut off power. More specifically, when it is difficult to stop operation of transmission and distribution facilities and the like, live wire work is conducted by a trained worker. Here, the trained worker is required to use insulating protective equipment or protective equipment.

Live wire work on the electric line is divided into direct live wire work and indirect live wire work. Indirect live wire work is a method of conducting live wire work indirectly using an insulating tool such as a hot stick. Although indirect live wire work is safe, there is a disadvantage of being labor intensive.

In addition, direct live wire work is a method in which a worker wears an insulated glove in an insulated bucket and works in direct contact with an electric wire in a live wire state. While direct live wire work is simple and saves working time, there is a disadvantage in that the worker is exposed to a high risk of electric shock, which often causes serious causalities. Live wire work includes inspection, repair, replacement, and cleaning of a wire component such as a support insulator. Depending on the types of live wire work, either a direct live wire work method or an indirect live wire work method may be appropriately used.

Meanwhile, utilization of a wire grip or a tensioner is high in various types of live wire work. The wire grip or the tensioner is a device used to pull or release a wire in order to obtain an appropriate dip at the time of adjusting a dip of a wire during live wire work. Here, in the case of the wire grip and the tensioner, a drum around which a rope or a wire is wound is controlled by forward and reverse rotation of the drum. Forward and reverse rotation of the drum is performed by a rotary device such as a ratchet connected to the drum.

That is, as an example, referring to FIG. 1, a conventional rotary device 10 is operated by adjusting forward and reverse rotation of a ratchet wheel 12 to which a belt drum 11 is coupled. Ratchets 13 and 13′ are respectively formed on opposite sides of the ratchet wheel 12 for forward and reverse rotation of the ratchet wheel 12. The ratchets 13 and 13′ are configured to be connected to a direction switching lever 15 connected through a link member 14. Here, by changing the direction of the direction switching lever 15, any one of the ratchets 13 and 13′ is engaged with the ratchet wheel 12, thereby allowing the ratchet wheel 12 to be rotated in the forward direction or the reverse direction.

However, in the case of the rotary device mounted on a conventional wire grip or tensioner as described above, when the forward direction or the reverse rotation of the rotary device is performed to wind or unwind a wire, it is required to operate the direction switching lever to adjust forward rotation or reverse rotation of the rotary device. Accordingly, operation is significantly inconvenient, and a worker needs to perform operation in close proximity to the wire. In consideration of these circumstances, there is a problem in that a worker is exposed to safety hazards.

### RELATED ART DOCUMENT

### Patent Document

(Patent Document 1) Korean Utility Model Registration No. 20-0314862
(Patent Document 2) Korean Patent No. 10-2161405

### DISCLOSURE

### Technical Problem

Therefore, the present invention has been made in view of the above problems, and it is an object of the present invention to provide an automatic direction switching pendulum-type rotary drive ratchet for an indirect live wire, configured to adjust, when winding or unwinding a wire grip or a tensioner, forward or reverse rotation of a pendulum drive shaft by operating an automatic reversing pawl and a pendulum drive shaft operating plate in accordance with reciprocating motion of a pendulum without operation of a direction switching lever, thereby enabling forward or reverse rotation of the pendulum drive shaft to be automatically performed by means of operating a rotary lever using a stick for the indirect live wire without a separate rotational direction switching operation.

In addition, the ratchet is configured such that the pendulum drive shaft is driven by a backstop ratchet ring operated by a multi-angle bundle pawl, thereby making it possible not only to reliably prevent reverse rotation but also to perform stable rotational driving by preventing backlash occurrence during reverse rotational driving.

### Technical Solution

In accordance with the present invention, the above and other objects can be accomplished by the provision of an automatic direction switching pendulum-type rotary drive ratchet for an indirect live wire, the automatic direction switching pendulum-type rotary drive ratchet including a body having a lever installation part formed on one side thereof,
a rotary operating lever including a rotary operating shaft, a cam, a rotary operating mechanism, and a buffer key, wherein the rotary operating shaft is axially installed in the lever installation part and has a rotating ring, wherein the cam is disposed at a tip portion of the rotary operating shaft and is formed at a location eccentric from a central portion of the tip portion, wherein the rotary operating mechanism is rotatably coupled to the rotary operating shaft at a rear side of the cam, has a movable long hole formed in a circumferential direction thereof, and has a locking protrusion formed to protrude from a circumference thereof, wherein the buffer key connects the rotary operating shaft to the rotary operating mechanism,
a pendulum drive shaft axially installed in the body from the other side of the body and formed to penetrate the body in a forward-and-rearward direction of the body,
a clutch part disposed on a front side of the body and coupled to a periphery of the pendulum drive shaft, wherein the clutch part prevents reverse rotation of an inner ring and operates forward or reverse rotation of the pendulum drive shaft through simultaneous reverse rotation of the inner ring and an outer ring,
a pendulum drive shaft operating plate disposed on a front side of the clutch part and coupled to the periphery of the pendulum drive shaft, wherein the pendulum drive shaft operating plate has saw teeth formed around a middle portion thereof,
a pendulum coupled to a rear side of the pendulum drive shaft operating plate and formed to protrude toward one side thereof so as to have a horizontal long hole configured to accommodate the cam therein, wherein the pendulum performs reciprocating pendulum motion relative to the pendulum drive shaft by operation of the cam and has an automatic revering pawl mounting groove formed in a front surface thereof and disposed between the rotary operating shaft and the pendulum drive shaft operating plate,
a support plate formed to penetrate a front circumference of the pendulum drive shaft operating plate and coupled to the pendulum, wherein the support plate is formed to protrude toward one side thereof,
an automatic reversing pawl having a pawl shaft coupled to the automatic revering pawl mounting groove, wherein the automatic reversing pawl interferes with the pendulum drive shaft operating plate and operates in reciprocating motion so as to provide forward or reverse rotational force of the pendulum drive shaft operating plate,
a pawl reversing key coupled to the pawl shaft with the automatic reversing pawl and formed to protrude from the support plate toward one side thereof, wherein the pawl reversing key interferes with the locking protrusion during rotation of the rotary operating mechanism so as to provide reciprocating rotational force of the automatic reversing pawl, and wherein the pawl reversing key has first and second reversing key spring balls installed thereon so as to constantly maintain horizontality thereof, wherein the first and second reversing key spring balls are formed to be symmetrical relative to the pawl shaft, and
a pendulum drive shaft rotary lever disposed on a front side of the pendulum drive shaft operating plate and coupled to the pendulum drive shaft and the pendulum drive shaft operating plate.

The clutch part may be formed as a backstop ratchet ring.

The backstop ratchet ring may include
an outer ring having an inner ring mounting hole formed to penetrate a central portion thereof, wherein the inner ring mounting hole has outer ring saw teeth formed on an inner peripheral surface thereof, wherein the outer ring saw teeth have straight portions and inclined portions continuously formed in a circumferential direction, wherein the outer ring has stopping grooves formed on an outer circumference thereof and disposed at regular intervals,
a circular ring-shaped inner ring having a shaft hole formed to penetrate a central portion thereof and configured to allow the pendulum drive shaft to be coupled thereto, wherein the inner ring is mounted in the inner ring mounting hole of the outer ring and has a plurality of bundle pawl mounting grooves formed on a circumference thereof and disposed at regular intervals,
a multi-angle bundle pawl unit having springs each installed in a corresponding one of the bundle pawl mounting grooves, wherein the multi-angle bundle pawl unit is operated to protrude outwards by spring elasticity of the spring and is engaged with the outer ring saw teeth of the outer ring so as to provide rotational force in one direction, and
a rotary control lever formed on the body and configured to interfere with a corresponding one of the stopping grooves of the outer ring or to be released therefrom so as to control rotation and stoppage of the outer ring.

The multi-angle bundle pawl unit may be formed of plural groups of first, second, and third multi-angle bundle pawls, and
the respective first, second, and third multi-angle bundle pawls may be configured to be engaged with the outer ring saw teeth of the outer ring at sequential positions respectively having different angles.

### Advantageous Effects

As described above, the present invention provides an automatic direction switching pendulum-type rotary drive ratchet for an indirect live wire, configured to automatically perform, using a stick for live wire work, forward or reverse rotation of a pendulum drive shaft operating plate through reciprocating motion of a pendulum in accordance with rotation direction adjustment of a rotary operating shaft, thereby having an effect of automatically performing forward rotation or reverse rotation of a pendulum drive shaft by simply conducting indirect live wire work without performing a separate rotation direction switching operation.

Additionally, a backstop ratchet ring is capable of preventing reverse rotation of the pendulum drive shaft, preventing backlash occurrence when the pendulum drive shaft is driven in the reverse direction, and constantly performing bidirectional rotation in a reliable manner, thereby having an effect of securing stability of a device.

### DESCRIPTION OF DRAWINGS

The above and other objects, features and other advantages of the present invention will be more clearly understood from the following detailed description taken in conjunction with the accompanying drawings, in which:

FIG. 1 is a simplified view showing a direction switching rotary device of a conventional wire grip;

FIG. 2 is a perspective view of an automatic direction switching pendulum-type rotary drive ratchet for an indirect live wire according to the present invention;

FIG. 3 is a plan cross-sectional view of the automatic direction switching pendulum-type rotary drive ratchet for the indirect live wire according to the present invention;

FIG. 4 is a cross-sectional view of a main part of the automatic direction switching pendulum-type rotary drive ratchet for the indirect live wire according to the present invention;

FIGS. 5 to 9 are views each showing a clutch part of the automatic direction switching pendulum-type rotary drive ratchet for the indirect live wire according to the present invention;

FIG. 10 is a view showing main parts of a pendulum, an automatic reversing pawl, and a pawl reversing key of the automatic direction switching pendulum-type rotary drive ratchet for the indirect live wire according to the present invention;

FIG. 11 is a view showing a state of using the automatic direction switching pendulum-type rotary drive ratchet for the indirect live wire according to the present invention;

FIG. 12 is a view showing a state of using the automatic direction switching pendulum-type rotary drive ratchet for the indirect live wire according to the present invention;

FIG. 13 is a view showing a forward direction operation state of the automatic direction switching pendulum-type rotary drive ratchet for the indirect live wire according to the present invention;

FIG. 14 is a view showing a forward direction operation state of a backstop ratchet ring of the automatic direction switching pendulum-type rotary drive ratchet for the indirect live wire according to the present invention;

FIG. 15 is a view showing a reverse direction operation state of the automatic direction switching pendulum-type rotary drive ratchet for the indirect live wire according to the present invention; and

FIG. 16 is a view showing a reverse direction operation state of the backstop ratchet ring of the automatic direction switching pendulum-type rotary drive ratchet for the indirect live wire according to the present invention.

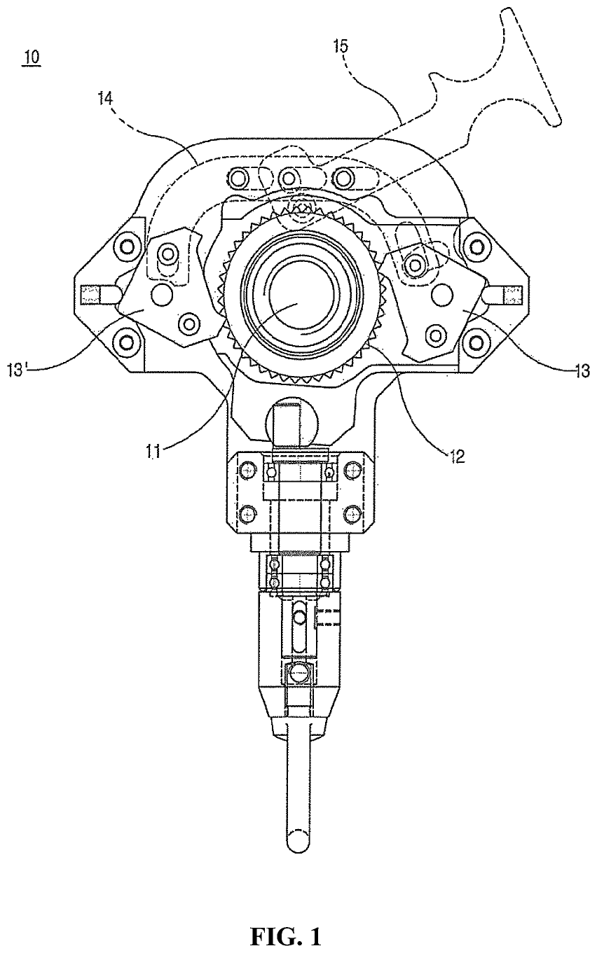

[Description of Reference Numerals]

| | |
|---|---|
| 100: Body | 110: Lever installation part |
| 200: Rotary operating lever | 210: Rotary operating shaft |
| 211: Rotary ring | 220: Cam |
| 230: Rotary operating mechanism | 231: Movable long hole |
| 232: Locking protrusion | 240: Buffer key |
| 300: Pendulum drive shaft | |
| 400: Clutch part | 401: Backstop ratchet ring |
| 410: Outer ring | 411: Inner ring mounting hole |
| 412: Outer ring saw teeth | 412a, 412b: Front and rear stepped |
| | portions |
| 413: Stopping groove | 420: Inner ring |
| 421: Shaft hole | 422: Bundle pawl mounting groove |
| 423: Seating protrusion | 424: Finishing plate support portion |
| 425: Finishing plate | 425a: Through hole |
| 430: Multi-angle bundle pawl unit | 431, 432, 433: First, second, and |
| | third multi-angle bundle pawls |
| 431a, 432a, 433a: First, second, | 431b, 432b, 433b: First, second, and |
| and third engagement tools | third engagement tool saw teeth |
| 440: Rotation control lever | |
| 500: Pendulum drive shaft | 510: Saw teeth |
| operating plate | |
| 600: Pendulum | 610: Horizontal long hole |
| 620: Automatic reversing pawl | |
| mounting groove | |
| 700: Support plate | |
| 800: Automatic reversing pawl | 801: Pawl shaft |
| 810, 810′: First and second | 821, 821′: First locking groove |
| locking protrusions | |
| 822, 822′: Second locking | |
| groove | |
| 830: Reversing key mounting | 840, 840′: First and second |
| groove | reversing pawl spring balls |
| 900: Pawl reversing key | 910, 910′: First and second |
| | reversing key spring balls |
| 1000: Pendulum drive shaft rotary | |
| lever | |

### Best Mode

Terms or words used in the description and claims should not be restrictively interpreted as having ordinary or dictionary meanings, but should be interpreted as having meanings and concepts conforming to the inventive concept on the basis of a principle that an inventor may properly define the concept of a term to explain his or her own invention in the best way.

Therefore, embodiments described in this specification and configurations shown in the drawings are only preferred embodiments of the present invention and do not represent the entire technical idea of the present invention. It should be understood that those skilled in the art will appreciate that various modifications, additions, and substitutions are possible, without departing from the scope and spirit of the invention as disclosed in the accompanying claims.

Hereinafter, preferred embodiments of the present invention will be described in detail with reference to the attached drawings.

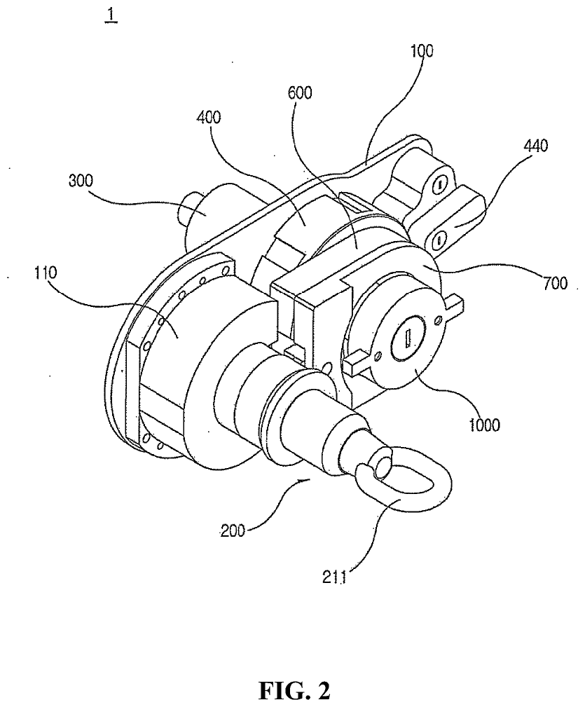

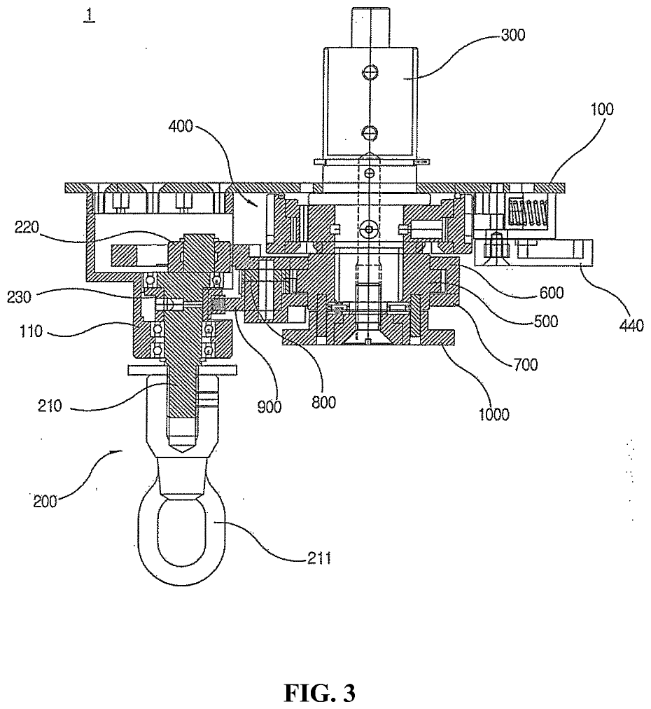

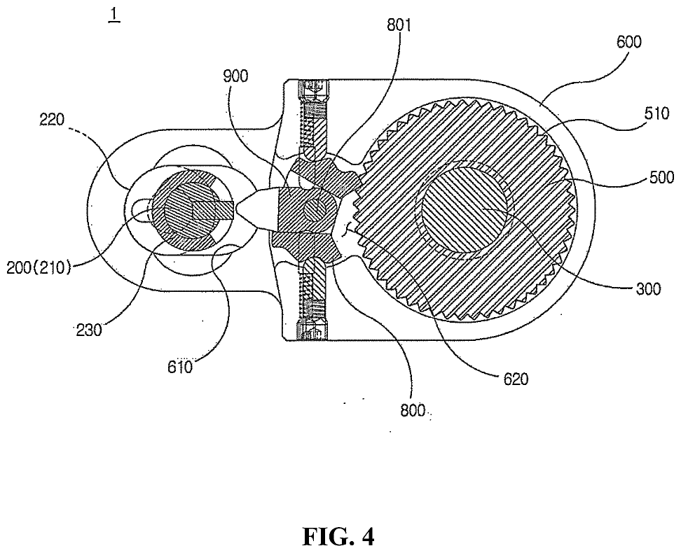

FIG. 2 is a perspective view of an automatic direction switching pendulum-type rotary drive ratchet for an indirect live wire according to the present invention, FIG. 3 is a plan cross-sectional view of the automatic direction switching pendulum-type rotary drive ratchet for the indirect live wire according to the present invention, and FIG. 4 is a cross-sectional view of a main part of the automatic direction switching pendulum-type rotary drive ratchet for the indirect live wire according to the present invention.

As shown in FIGS. 2 to 4, an automatic direction switching pendulum-type rotary drive ratchet for an indirect live wire 1 according to the present invention includes a body 100, a rotary operating lever 200, a pendulum drive shaft 300, a clutch part 400, a pendulum drive shaft operating plate 500, a pendulum 600, a support plate 700, an automatic revering pawl 800, a pawl reversing key 900, and a pendulum drive shaft rotary lever 1000.

First, the body 100 is configured to form a basic structure of the automatic direction switching pendulum-type rotary drive ratchet for the indirect live wire 1 according to the present invention. Further, the body 100 is formed to have a vertical plate body and is configured to have a lever installation part 110 provided on one side thereof (left side in the drawing) and formed to have a hollow interior.

In the configuration of the automatic direction switching pendulum-type rotary drive ratchet for the indirect live wire 1 according to the present invention, the rotary operating lever 200 is configured to provide operating force for forward rotation of the pendulum drive shaft 300 or reverse rotation thereof, which will be described later.

To this end, the rotary operating lever 200 is mainly formed of a rotary operating shaft 210 horizontally installed in the lever installation part 110. Here, the front end of the rotary operating shaft 210 is located in the lever installation part 110, and the rear end thereof protrudes toward the outer side of the lever installation part 110 so as to form a rotary ring 211.

In addition, the rotary operating lever 200 includes a cam 220 provided at a tip portion of the rotary operating shaft 210 and disposed at a location eccentric from a central portion of the tip portion to one side.

In addition, the rotary operating lever 200 includes a rotary operating mechanism 230 provided around the rotary operating shaft 210 and disposed on the rear side of the cam 220. The rotary operating mechanism 230 is configured to be slidably coupled to the rotary operating shaft 210.

In addition, a movable long hole 231 is formed on one side of the circumference of the rotary operating mechanism 230 so as to form an angle of about 1100 in the circumferential direction, and a locking protrusion 232 is formed to protrude around the other side of the circumference of the rotary operating mechanism 230.

In addition, the rotary operating lever 200 includes a buffer key 240 configured to provide connecting force between the rotary operating shaft 210 and the rotary operating mechanism 230. In this case, one side of the buffer key 240 is configured to be fixed to the rotary operating shaft 210 and the other side thereof is configured to be located inside the movable long hole 231 of the rotary operating mechanism 230.

Here, when the rotary operating shaft 210 is rotated in the forward direction or reverse direction, the buffer key 240 idles for a predetermined time within the movable long hole 231. When the buffer key 240 is caught at one end of the movable long hole 231, the buffer key 240 is configured to rotate the rotary operating mechanism 230. In this operation process, it is possible to prevent shock overload on the pendulum drive shaft operating plate 500, which will be described later. Here, the shock overload is caused by sudden rotation.

In the configuration of the automatic direction switching pendulum-type rotary drive ratchet for the indirect live wire 1 according to the present invention, the pendulum drive shaft 300 is substantially configured to have forward or reverse rotational force and is formed to penetrate the body 100 from the other side of the body 100 in the forward-and-rearward direction.

Meanwhile, in the present invention, the pendulum drive shaft 300 may have various shapes at a location at which the where the pendulum drive shaft 300 protrudes toward the rear side of the body 100. Here, the pendulum drive shaft 300 may be used in combination with an ordinary wire grip or tensioner.

In the configuration of the automatic direction switching pendulum-type rotary drive ratchet for the indirect live wire 1 according to the present invention, the clutch part 400 is configured to implement forward rotation of the pendulum drive shaft 300 or reverse rotation thereof. The pendulum drive shaft 300 is configured to penetrate the body 100 from the front side of the body 100 so as to be coupled to the clutch part 400.

Meanwhile, in the present invention, the configuration of the clutch part 400 is not limited. For example, the clutch part may be configured as a cam clutch in which a cam is formed between an inner ring and an outer ring, only the inner ring is rotatable when the inner ring is rotated in the forward direction, and the inner ring and the outer ring are simultaneously rotatable when the inner ring is rotated in the reverse direction.

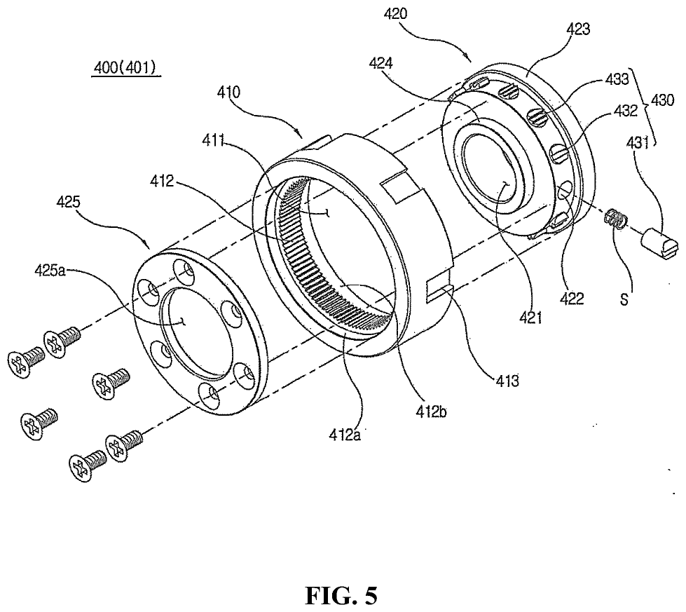

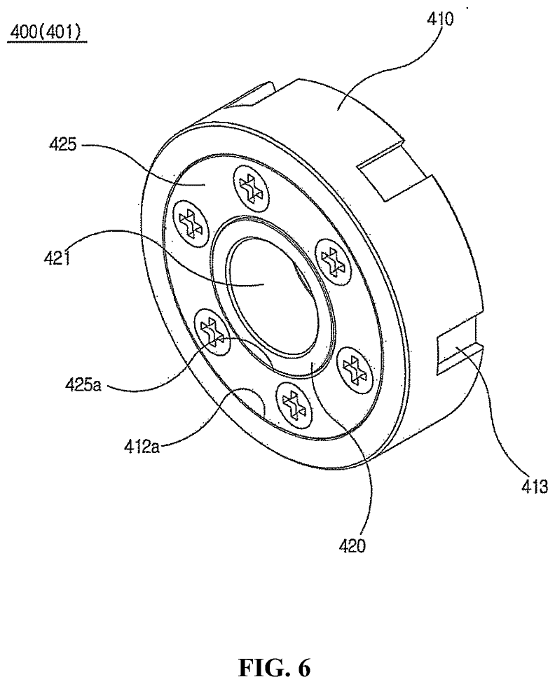

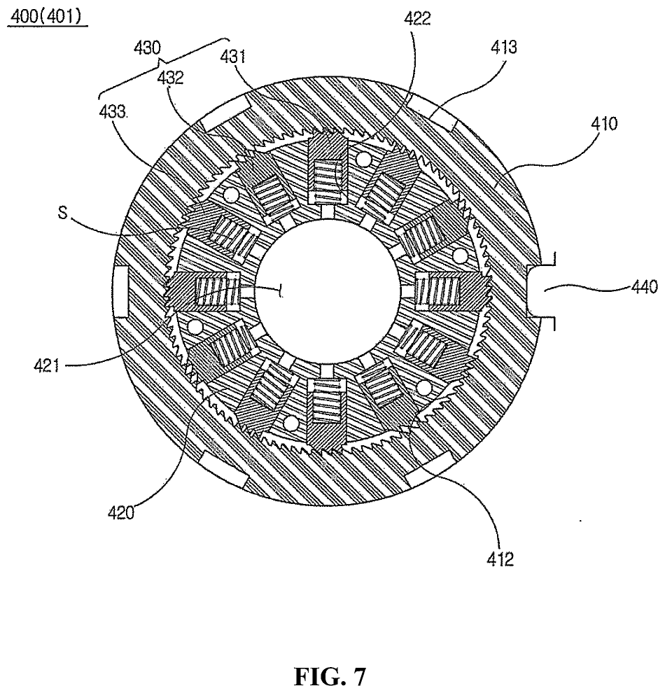

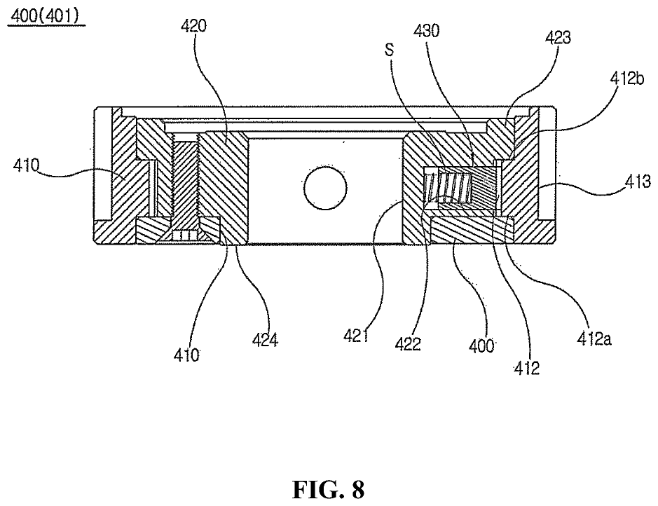

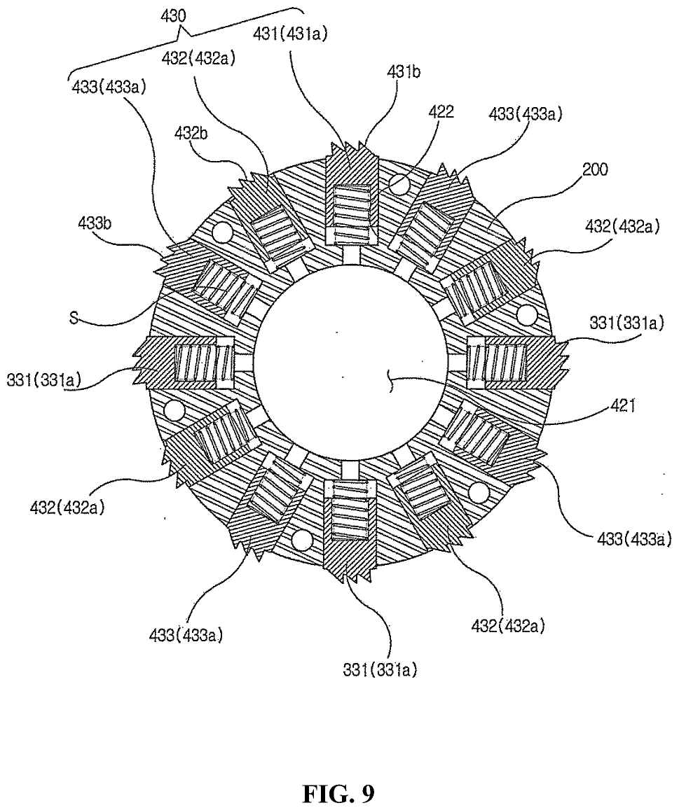

In addition, the clutch part 400 may be configured as a backstop ratchet ring 401 with reference to FIGS. 5 to 9. In the present invention, the backstop ratchet ring 401 includes an outer ring 410, an inner ring 420, a multi-angle bundle pawl unit 430, and a rotation control lever 440.

First, in the configuration of the backstop ratchet ring 401, the outer ring 410 is configured to output power to the outside. The outer ring 410 has an inner ring mounting hole 411 disposed at a central portion thereof and configured to allow an inner ring 420 to be described later to be mounted therein. Here, the inner ring mounting hole 411 is formed to have a circular shape in a state of penetrating the outer ring 410.

In this case, in the present invention, the outer ring 410 is configured to have outer ring saw teeth 412 formed on the inner peripheral surface of the inner ring mounting hole 411, and the outer ring saw teeth 412 are configured to have straight portions and inclined portions that are continuously formed.

Meanwhile, in the present invention, each of the straight portions forming the outer ring saw teeth 412 is configured to be caught during power transmission, and each of the inclined portions forming the outer ring saw teeth 412 is configured to guide slipping movement during idling operation.

In addition, in the present invention, the outer ring 410 may further include a plurality of stopping grooves 413 formed on the outer circumference thereof at regular intervals and configured to allow the rotation control stoppers 440 to be respectively caught therein or released therefrom.

In the configuration of the backstop ratchet ring 401, the inner ring 420 is configured to substantially transmit main power. Further, the inner ring 420 interferes with the outer ring 410 so as to transmit main power to the outer ring 410 or is released from the outer ring 410 so as to release the main power from the outer ring 410.

To this end, in the present invention, the inner ring 420 is configured to have a circular ring shape. Here, the inner ring 420 has a shaft hole 421 formed to pass through a central portion thereof and configured to allow the pendulum drive shaft 300 provided to transmit rotational power to be coupled thereto. Further, the inner ring 420 is configured to be mounted in the inner ring mounting hole 411 of the outer ring 410.

In addition, the inner ring 420 has a plurality of bundle pawl mounting grooves 422 formed on the outer circumference thereof at regular intervals in the circumferential direction and configured to enable first, second, and third multi-angle bundle pawls 431, 432, and 433 to be described later to be respectively mounted therein.

Meanwhile, in the present invention, the outer ring 410 and the inner ring 420 are configured to enable close coupling therebetween. Further, sliding operation may be stably performed when the outer ring 410 and the inner ring 420 are coupled to each other.

To this end, first, each of the outer ring saw teeth 412 of the outer ring 410 is configured to protrude toward the inside of the inner ring mounting hole 411 by a predetermined amount. Accordingly, front and rear stepped portions 412a and 412b are respectively formed at the front side and the rear side of the outer ring saw teeth 412.

In addition, the inner ring 420 is configured to have a seating protrusion 423 formed to protrude from the rear circumference thereof and slidably seated on the rear stepped portion 412b of the outer ring 410. Further, the inner ring 420 is configured to have a finishing plate support portion 424 formed to protrude from the front side thereof so as to extend from the shaft hole 421.

Further, the front side of the inner ring 420 is configured to be finished with a finishing plate 425. Here, the circumference of the finishing plate 425 is configured to be seated on the front stepped portion 412a of the outer ring 410 and to be bolted to the inner ring 420, thereby constraining the outer ring saw teeth 412. Further, the finishing plate 425 is configured to have a through hole 425a formed in a central portion thereof and configured to allow the finishing plate support portion 424 of the inner ring 420 to pass therethrough.

In the configuration of the backstop ratchet ring 401, the multi-angle bundle pawl unit 430 serves as a means to transmit power of the inner ring 420 to the outer ring 410 or release power of the inner ring 420 from the outer ring 410 in response to the outer ring saw teeth 412 of the outer ring 410. In the present invention, the multi-angle bundle pawl unit 430 is formed of a plurality of groups including the first, second, and third multi-angle bundle pawls 431, 432, and 433.

To this end, the first, second, and third multi-angle bundle pawls 431, 432, and 433 respectively have springs S each installed in a corresponding one of the bundle pawl mounting grooves 422, thereby allowing the first, second, and third multi-angle bundle pawls 431, 432, and 433 to protrude from the outer circumference of the inner ring 420. Further, the first, second, and third multi-angle bundle pawls 431, 432, and 433 are configured to be engaged with the outer ring saw teeth 412 of the outer ring 410, thereby providing rotational force in one direction.

In this case, in the present invention, the first, second, and third multi-angle bundle pawls 431, 432, and 433 are configured to form three groups. Here, each of the three groups may be formed of a corresponding one of first, second, and third engagement tools 431a, 432a, and 433a, in which each of the radially arranged (that is, arranged at 900 intervals) four first engagement tools 431a, four second engagement tools 432a, and four third engagement tools 433a forms one group.

In the present invention, the first, second, and third engaging tools 431a, 432a, and 433a corresponding to respective groups are configured to have protruding force by respectively inserting the springs S into the bundle pawl mounting grooves 422. The first, second, and third engaging tools 431a, 432a, and 433a have engagement tool saw teeth 431b, 432b, and 433b respectively provided at tip portions thereof, in which each of the engagement tool saw teeth 431b, 432b, and 433b is formed to have a straight portion and an inclined portion so as to be engaged with the outer ring saw teeth 412 of the outer ring 410.

Particularly, in the present invention, when the first, second, and third engagement tools 431a, 432a, and 433a respectively corresponding to the first, second, and third multi-angle bundle pawls 431, 432, and 433 of the respective groups are respectively mounted in the bundle pawl mounting grooves 422, the first, second, and third engagement tools 431a, 432a, and 433a are respectively disposed at positions where the first, second, and third engagement tools 431a, 432a, and 433a intersect each other. That is, the first engagement tool 431a of the first multi-angle bundle pawl 431, the second engagement tool 432a of the second multi-angle bundle pawl 432, and the third engagement tool 433a of the third multi-angle bundle pawl 433 are continuously and repeatedly formed in one rotational direction. In this manner, the engagement tool saw teeth 431b, 432b, and 433b are configured to be engaged with the outer ring saw teeth 412 at sequential positions respectively having different angles.

That is, in the present invention, any one of the first, second, and third engagement tool saw teeth 431b, 432b, and 433b of the first, second, and third engagement tool 431a, 432a, and 433a of the first, second, and third multi-angle bundle pawls 431, 432, and 433 is engaged with the outer ring saw teeth 412 of the outer ring 410. For example, when the straight portions of the engagement tool saw teeth 431b of the first engagement tool 431a are respectively in contact with the straight portions of the outer ring saw teeth 412, the straight portions of the engagement tool saw teeth 432b of the second engagement tool 432a are respectively located at the ends of the inclined portions of the outer ring saw teeth 412. As a result, the engagement tool saw teeth 432b are not engaged with the outer ring saw teeth 412. In addition, the straight portions of the engagement tool saw teeth 433b of the third engagement tool 433a are respectively located at the middle portions of the inclined portions of the outer ring saw teeth 412. In this manner, segmented engagement sections of the engagement tool saw teeth 431b, 432b, and 433b are provided within one pitch of the outer ring saw teeth 412, thereby minimizing a gap between the saw teeth.

Meanwhile, in the embodiment of the present invention, the first, second, and third multi-angle bundle pawls 431, 432, and 433 forming a plurality of groups have been described as three groups, but the present invention is not limited thereto. The first, second, and third multi-angle bundle pawls 431, 432, and 433 may be arranged in various configurations at equal intervals.

For example, the plurality of groups may be formed of four groups of multi-angle bundle pawls, and each of the four groups may be formed of four engagement tools. Alternatively, the plurality of groups may be formed of three groups of multi-angle bundle pawls, and each of the three groups may be formed of eight engagement tools. As described above, the number of groups and the number of engagement tools are adjusted, thereby making it possible to control a degree of precision depending on the purpose of use of the backstop ratchet ring 401.

In the configuration of the backstop ratchet ring 401, the rotation control lever 440 is configured to control rotation and stoppage of the outer ring 410.

To this end, the rotation control lever 440 is configured to be axially installed in the body 100 and to have a spring installed in the body 100. In this manner, the rotation control lever 440 is configured to be inserted into and removed from the stopping groove 413 of the outer ring 410 through rotational operation thereof. When the rotation control lever 440 is inserted thereinto, rotation of the outer ring 410 is blocked, and when the rotation control lever 440 is removed therefrom, rotation of the outer ring 410 is possible.

In the configuration of the automatic direction switching pendulum-type rotary drive ratchet for the indirect live wire 1 according to the present invention, the pendulum drive shaft operating plate 500 is configured to transmit rotational force to the pendulum drive shaft 300.

To this end, the pendulum drive shaft operating plate 500 is formed to have a circular plate shape with a certain thickness so as to be coupled to the periphery of the pendulum drive shaft 300 on the front side of the clutch part 400. Here, the pendulum drive shaft operating plate 500 has triangular-shaped saw teeth 510 provided around a middle portion thereof and formed to protrude from the middle portion.

In the configuration of the automatic direction switching pendulum-type rotary drive ratchet for the indirect live wire 1 according to the present invention, the pendulum 600 is configured to control, through pendulum motion, reciprocating rotation operation of an automatic reversing pawl 800 to be described later.

To this end, the pendulum 600 is configured to penetrate the rear side of the pendulum drive shaft operating plate 500 without rotational interference. Further, the pendulum 600 protrudes from one side thereof and has a horizontal long hole 610 formed therein and configured to accommodate the cam 220 of the rotary operating lever 200. When the cam 220 is rotated, the cam 220 interferes with the horizontal long hole 610 so as to perform pendulum motion in which the pendulum 600 reciprocates relative to the pendulum drive shaft 300.

In addition, the pendulum 600 has an automatic reversing pawl mounting groove 620 formed therein and configured to allow the automatic reversing pawl 800 to be described later to be mounted on the front surface between the rotary operating shaft 210 and the pendulum drive shaft operating plate 500.

In the configuration of the automatic direction switching pendulum-type rotary drive ratchet for the indirect live wire 1 according to the present invention, the support plate 700 is configured to allow the pawl reversing key 900 to be described later to be mounted thereon.

To this end, the support plate 700 is configured to penetrate the front side of the pendulum drive shaft operating plate 500 without rotational interference. Further, the support plate 700 is configured to be coupled to the pendulum 600 so as to constrain the pendulum drive shaft operating plate 500, and is formed to protrude toward the rotary operating shaft 210.

In the configuration of the automatic direction switching pendulum-type rotary drive ratchet for the indirect live wire 1 according to the present invention, the automatic reversing pawl 800 is configured to interfere with the pendulum drive shaft operating plate 500 so as to automatically perform forward rotation or reverse rotation of the pendulum drive shaft operating plate 500.

To this end, the automatic reversing pawl 800 is configured to be coupled to the automatic reversing pawl mounting groove 620 of the pendulum 600 with a pawl shaft 801, thereby enabling the pendulum drive shaft operating plate 500 to perform reciprocating pendulum motion.

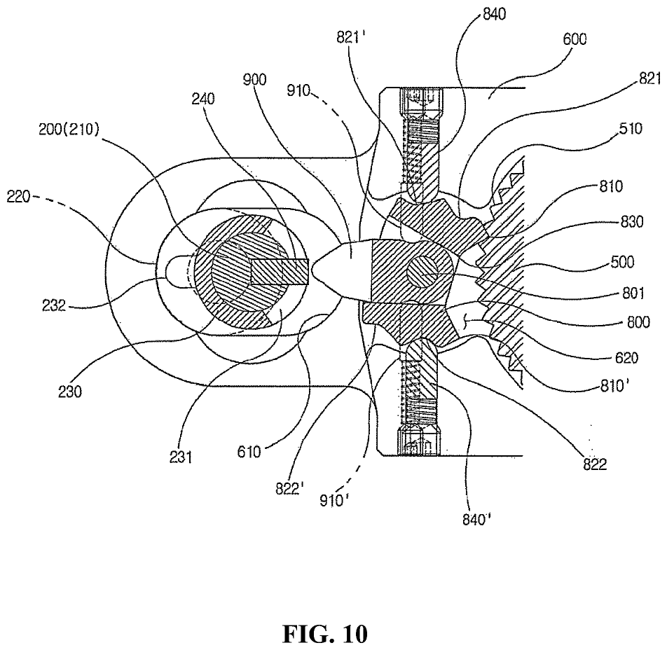

Meanwhile, in the present invention, referring to FIG. 10, the automatic reversing pawl 800 has first and second triangular locking protrusions 810 and 810′ formed at a tip portion thereof, that is, disposed toward the side of the pendulum drive shaft operating plate 500, in which the first and second triangular locking protrusions 810 and 810′ are formed to protrude symmetrically and are selectively engaged with the saw teeth 510 of the pendulum drive shaft operating plate 500.

Further, the automatic reversing pawl 800 includes first locking grooves 821 and 821′ and second locking grooves 822 and 822′ each formed to have a curved curvature and disposed around the automatic reversing pawl 800. In this case, the first locking grooves 821 821′ and the second locking grooves 822 and 822′ are configured to be symmetrical to each other so that the first locking groove 821 and the second locking groove 822 are respectively located on the first and second locking protrusions 810 and 810′.

Additionally, the automatic reversing pawl 800 has a reversing key mounting groove 830 formed at a central portion thereof and configured to allow the pawl revering key 900 to be described later to be mounted therein. The reversing key mounting groove 830 is configured to have a tapered groove shape extending from the pendulum drive shaft operating plate 500 side to the rotary operating shaft 210 side.

Meanwhile, the automatic reversing pawl 800 is configured to be installed through first and second reversing pawl spring balls 840 and 840′. The first and second reversing pawl spring balls 840 and 840′ are configured to be coupled to the pendulum 600 so as to have elasticity allowing the first and second reversing pawl spring balls 840 and 840′ to protrude toward the automatic reversing pawl 800.

In this case, in the present invention, the first and second reversing pawl spring balls 840 and 840′ are configured to interfere with the first locking grooves 821 and 821′ and the second locking grooves 822 and 822′. Here, the first reversing pawl spring ball 840 is configured to interfere with any corresponding one of the first locking grooves 821 and 821′ at a location at which the first reversing pawl spring ball 840 and the corresponding one intersect each other, and the second reversing pawl spring ball 840′ is configured to interfere with any corresponding one of the second locking grooves 822 and 822′ at a location at which the second reversing pawl spring ball 840′ and the corresponding one intersect each other.

For example, when the pendulum drive shaft operating plate 500 is rotated in the forward direction, that is, rotated clockwise, the first revering pawl spring ball 840 located on one side of the pendulum 600 is desirably caught in the first locking groove 821′ located on one side of the automatic reversing pawl 800, and the first reverse pawl spring ball 840′ located on the other side of the pendulum 600 is desirably caught in the second locking groove 822 located on the other side of the automatic reversing pawl 800. Conversely, when the pendulum drive shaft operating plate 500 is rotated counterclockwise, the first revering pawl spring ball 840 located on one side of the pendulum 600 is desirably caught in the first locking groove 821 located on one side of the automatic reversing pawl 800, and the first reverse pawl spring ball 840′ located on the other side of the pendulum 600 is desirably caught in the second locking groove 822′ located on the other side of the automatic reversing pawl 800.

In the configuration of the automatic direction switching pendulum-type rotary drive ratchet for the indirect live wire 1 according to the present invention, the pawl reversing key 900 is configured to provide reciprocating rotational force to the automatic revering pawl 800.

To this end, the pawl reversing key 900 is accommodated in the reversing key mounting groove 830 of the automatic reversing pawl 800. Further, the pawl reversing key 900 is coupled to the support plate 700 with the same pawl shaft 801 as the automatic reversing pawl 800 and protrudes from one side thereof, that is, protrudes toward the rotary operating shaft 210. In the process of rotating the rotary operating shaft 210, the pawl reversing key 900 is configured to interfere with the locking protrusion 232 of the rotary operating mechanism 230, thereby performing reciprocating pendulum motion.

In this case, the pawl reversing key 900 is configured to have horizontal force so as to constantly maintain horizontality thereof. To this end, opposite sides of the pawl reversing key 900 are configured to be elastically installed by first and second reversing key spring balls 910 and 910′ respectively formed on opposite sides of the support plate 700 relative to the pawl shaft 801.

In the configuration of the automatic direction switching pendulum-type rotary drive ratchet for the indirect live wire 1 according to the present invention, the pendulum drive shaft rotary lever 1000 is configured to transmit rotational force of the pendulum drive shaft operating plate 500 to the pendulum drive shaft 300.

To this end, the pendulum drive shaft rotary lever 1000 is configured to be coupled to the front side of the pendulum drive shaft 300 and the pendulum drive shaft operating plate 500. Further, the pendulum drive shaft rotary lever 1000 is configured to rotate in conjunction with the pendulum drive shaft 300 and the pendulum drive shaft operating plate 500.

Hereinafter, the operation of the automatic direction switching pendulum-type rotary drive ratchet for the indirect live wire according to the present invention having the above configuration will be described in detail with reference to the attached drawings.

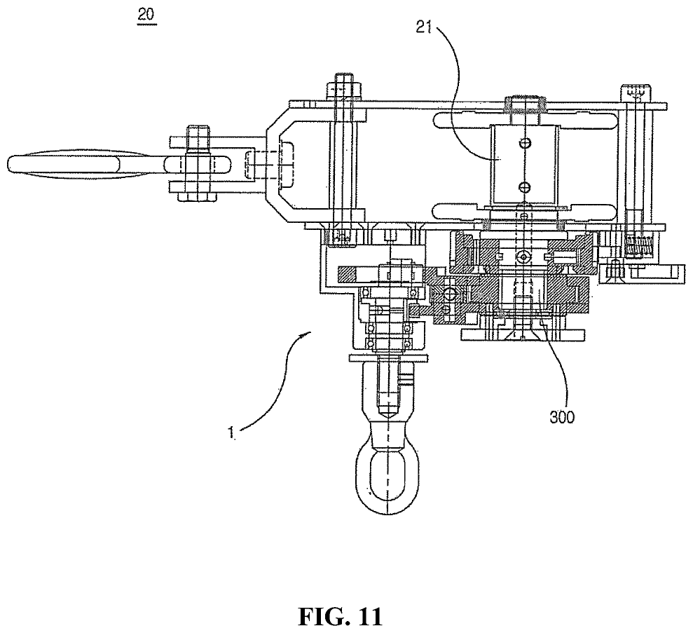

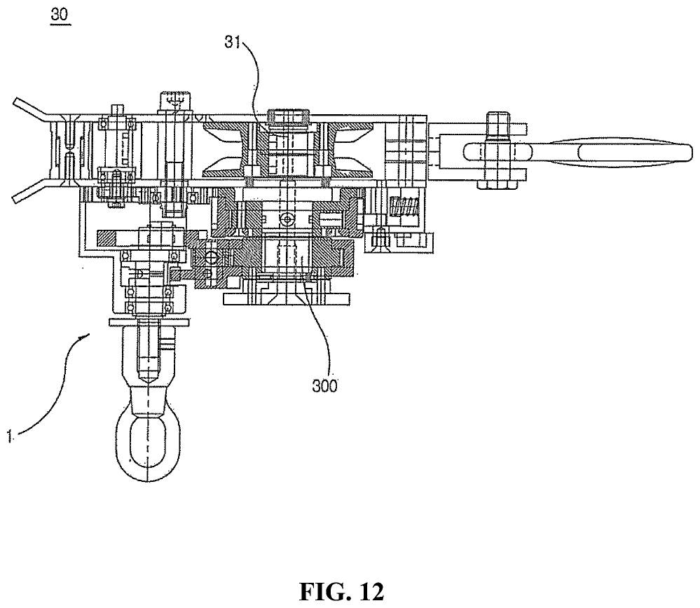

With reference to FIGS. 2 to 10, the automatic direction switching pendulum-type rotary drive ratchet for the indirect live wire 1 according to the present invention is connected to a drum 21 and a drum 31 of a wire grip 20 and a tensioner 30 using the pendulum drive shaft 300, as shown in FIGS. 11 and 12. In this manner, the automatic direction switching pendulum-type rotary drive ratchet for the indirect live wire 1 is configured to provide forward or reverse rotational force to the drums 21 and 31. In this case, even if a separate direction switching lever is not operated, by using a live wire working stick equipped with an electric mechanism and the like, it is possible to perform forward or reverse rotation of the pendulum drive shaft 300 by simply adjusting the rotation direction of the rotary operating shaft 210 through indirect live wire work in a state in which a safe distance between a worker and a distribution line is secured.

Accordingly, as an example, in the automatic direction switching pendulum-type rotary drive ratchet for the indirect live wire 1 according to the present invention, in order to wind a belt to provide tension of the wire grip 20 and the tensioner 30, the pendulum drive shaft 300 is rotatably driven clockwise, that is, in the forward direction. Hereinafter, the above-described operating state will be described.

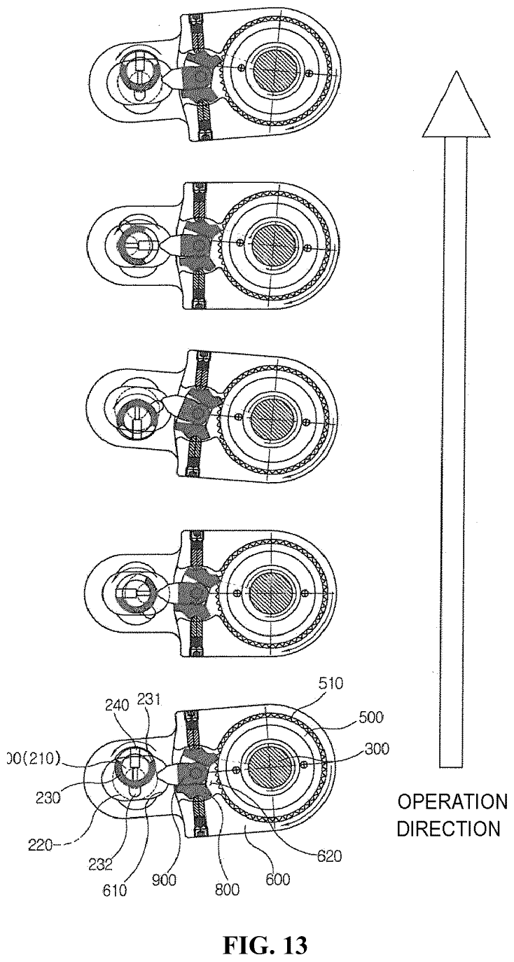

To this end, referring to FIG. 13, the rotary operating lever 200 is simply rotated counterclockwise. At this time, the rotation control lever 440 is inserted into one of the stopping grooves 413 of the outer ring 410 so as to prevent rotation of the outer ring 410.

Accordingly, when the rotary operating lever 200 is operated to rotate the rotary operating shaft 210 counterclockwise, the cam 220 is rotated within the horizontal long hole 610 of the pendulum 600. In this process, the pendulum 600 is subjected to reciprocating pendulum motion relative to the pawl shaft 801.

Simultaneously, the locking protrusion 232 of the rotary operating mechanism 230 formed on the rotary operating shaft 210 turns the pawl reversing key 900 toward the first locking grooves 821 and 821′. Accordingly, the pawl reversing key 900 pushes the automatic revering pawl 800 in the direction of the first locking grooves 821 and 821′ and rotates the same clockwise around the pawl shaft 801. In this case, the first locking protrusion 810 on the first locking groove 821 side is engaged with the saw teeth 510 of the pendulum drive shaft operating plate 500.

Accordingly, when the rotary operating shaft 210 is continuously rotated, the pendulum 600 performs reciprocating pendulum motion by operation of the cam 220 and the horizontal long hole 610. In this process, the pawl reversing key 900 rotated in the rotation direction due to interference with the locking protrusion 232 of the rotary operating mechanism 230 supports the first locking grooves 821 and 821′ side of the automatic reversing pawl 800 and rotatably pushes the pendulum drive shaft operating plate 500 that is engaged with the automatic reversing pawl 800 and performs reciprocating pendulum motion with the pendulum 600. In this case, the pendulum drive shaft 300 is rotated in conjunction with forward rotation of the pendulum drive shaft operating plate 500.

Meanwhile, in the present invention, as described above, reverse rotation of the pendulum drive shaft 300 is prevented when rotation of the pendulum drive shaft 300 is performed to obtain tension, which is made possible by the clutch part 400.

Here, in the present invention, the clutch part 400 is formed of the backstop ratchet ring 401. Reverse rotation is prevented by the backstop ratchet ring 401, and an operation process of the backstop ratchet ring 401 will be described below.

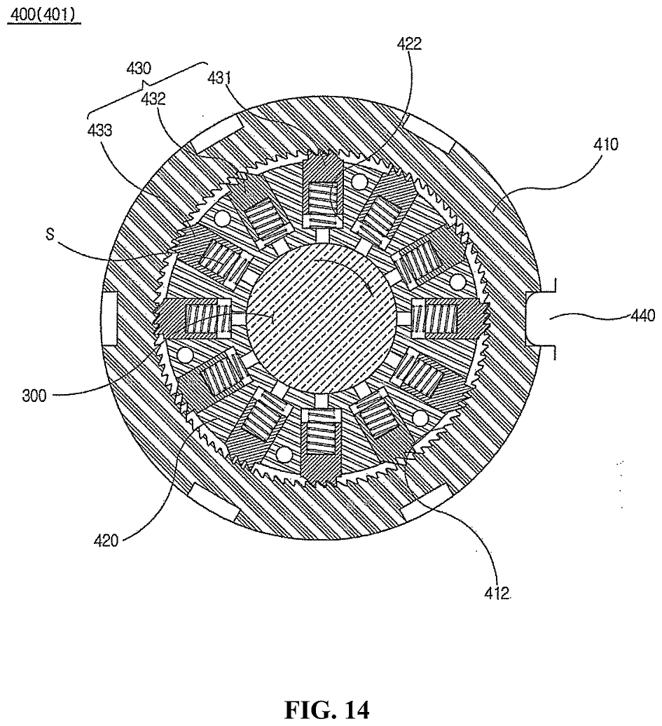

Referring to FIG. 14, when the inner ring 420 coupled to the pendulum drive shaft 300 is rotated in the forward direction, the inclined portions of the engagement tool saw teeth 431b, 432b, and 433b of the first, second, and third engagement tools 431a, 432a, and 433a respectively forming the first, second, and third multi-angle bundle pawls 431, 432, and 433 pass over the inclined portions of the outer ring saw teeth 412 of the outer ring 410.

That is, since the springs S are respectively installed in the first, second, and third engagement tools 431a, 432a, and 433a of the inner ring 420, the engagement tool saw teeth 431b, 432b, and 433b that pass over the outer ring saw teeth 412 are pushed rearwards by compressive force of the springs S, and simultaneously, the inclined portions of the outer ring saw teeth 412 and the inclined portions of the engagement tool saw teeth 431b, 432b, and 433b slide and move over each other.

Meanwhile, in a state in which the forward drive as described above is stopped, rotational force causing the inner ring 420 to be rotated in the reverse direction may be generated by belt tension of the gear grip 20 or the tensioner 30. In this case, in the backstop ratchet ring 401, any one of the engagement tool saw teeth 431b, 432b, and 433b respectively formed on the first, second, and third engagement tools 431a, 432a, and 433a of the first, second, and third multi-angle bundle pawls 431, 432, and 433 is engaged with the outer ring saw teeth 412, thereby preventing the reverse rotation of the inner ring 420. Accordingly, it is possible to stably wind the belt of the gear grip 20 or the tensioner 30 and to reliably apply tension to the gear grip 20 or the tensioner 30.

Conversely, when the belt is unwound so as to release tension of the gear grip 20 or the tensioner 30, the pendulum drive shaft 300 is rotated counterclockwise, that is, in the reverse direction. The above-described operating state of the pendulum drive shaft 300 will be described below.

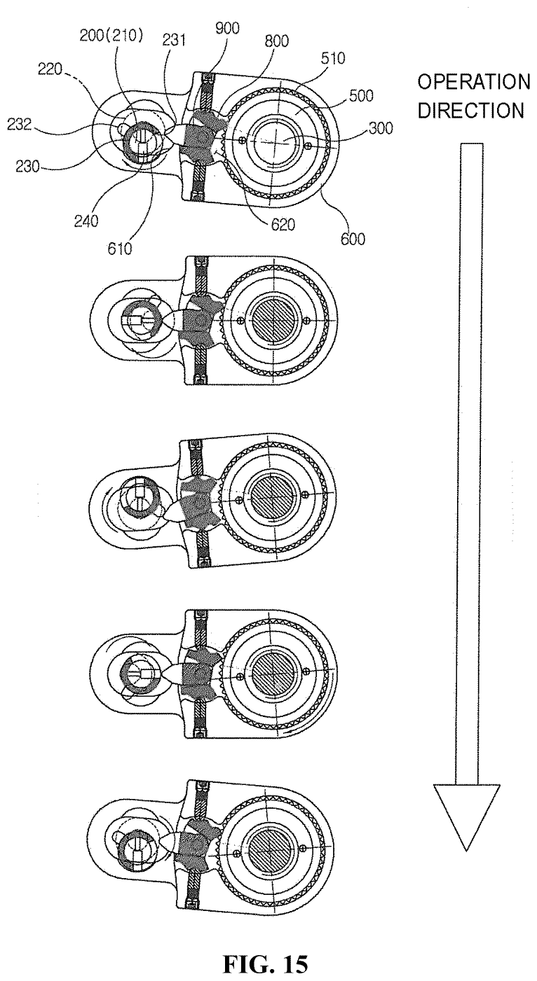

To this end, referring to FIG. 15, the outer ring 410 may be rotated by separating the rotary operating lever 200 from the stopping groove 413 of the outer ring 410 without operation of a separate direction switching device.

Accordingly, when the rotary operating lever 200 is operated to rotate the rotary operating shaft 210 clockwise, the cam 220 is rotated within the horizontal long hole 610 of the pendulum 600. In this process, the pendulum 600 is subjected to reciprocating pendulum motion relative to the pawl shaft 801.

In this case, the locking protrusion 232 of the rotary operating mechanism 230 formed on the rotary operating shaft 210 rotatably pushes the pawl reversing key 900 toward the second locking grooves 822 and 822′. Accordingly, the pawl reversing key 900 pushes the automatic reversing pawl 800 in the direction of the second locking grooves 822 and 822′ so as to rotate the automatic reversing pawl 800 counterclockwise around the pawl shaft 801. At this time, the second locking protrusion 810′ on the second locking groove 822 side of the automatic reversing pawl 800 is engaged with the saw teeth 510 of the pendulum drive shaft operating plate 500.

Accordingly, when the rotary operating shaft 210 is continuously rotated, the pendulum 600 performs reciprocating pendulum motion by operation of the cam 220 and the horizontal long hole 610. In this process, the pawl reversing key 900 rotated in the rotation direction due to interference with the locking protrusion 232 of the rotary operating mechanism 230 supports the second locking groove 822′ side of the automatic reversing pawl 800 and rotatably pushes the pendulum drive shaft operating plate 500 that is engaged with the automatic reversing pawl 800 and performs reciprocating pendulum motion with the pendulum 600. In this case, the pendulum drive shaft 300 is rotated in conjunction with reverse rotation of the pendulum drive shaft operating plate 500.

Meanwhile, when the pendulum drive shaft 300 is rotated in the reverse direction as described above, the backstop ratchet ring 401 connected to the pendulum drive shaft 300 is also rotated. In this case, in the backstop ratchet ring 401, any one of the engagement tool saw teeth 431b, 432b, and 433b respectively formed on the first, second, and third engagement tools 431a, 432a, and 433a of the first, second, and third multi-angle bundle pawls 431, 432, and 433 is engaged with the outer ring saw teeth 412 and becomes rotatable in conjunction with rotation of the outer ring 410.

Meanwhile, in the present invention, as described above, when the outer ring 410 is driven by the reverse operation of the inner ring 420, backlash (backward movement) of the inner ring 420 is maximally reduced so that possibility of backlash is close to zero, thereby making it possible to prevent impact during power transmission.

The above-described operation may be performed by the multi-angle bundle pawl unit 430 configured to transmit rotational power of the inner ring 420 to the outer ring 410.

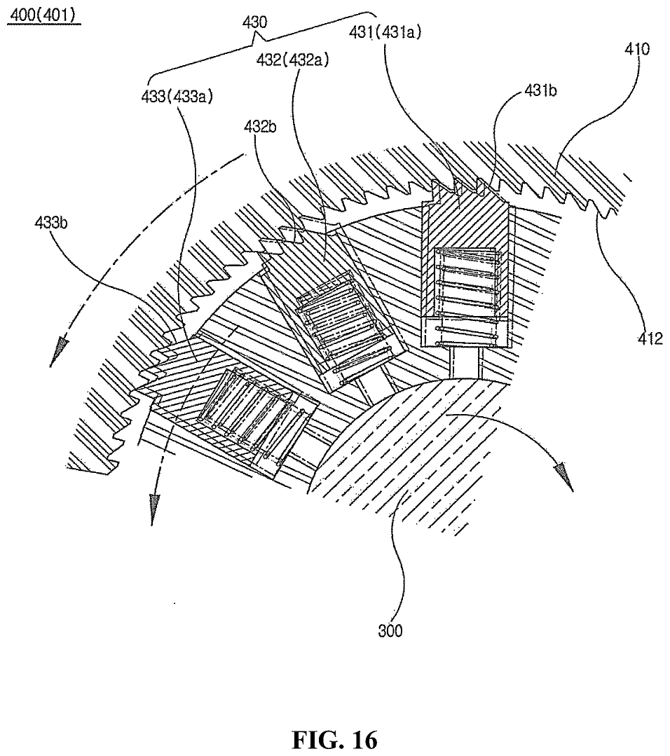

That is, with reference to FIG. 16, in the present invention, the first, second, and third engagement tool saw teeth 431b, 432b, and 433b of the first, second, and third engagement tool 431a, 432a, and 433a of the first, second, and third multi-angle bundle pawls 431, 432, and 433 are sequentially engaged with the outer ring saw teeth 412 of the outer ring 410.

For example, when the straight portions of the engagement tool saw teeth 431b of the first engagement tool 431a are respectively in contact with the straight portions of the outer ring saw teeth 412 so as to enter the engagement state therebetween, the straight portions of the engagement tool saw teeth 432b of the second engagement tool 432a are respectively located at the ends of the inclined portions of the outer ring saw teeth 412. In this manner, the engagement tool saw teeth 432b are not engaged with the outer ring saw teeth 412. In addition, the straight portions of the engagement tool saw teeth 433b of the third engagement tool 433a are respectively located at the middle portions of the inclined portions of the outer ring saw teeth 412. Accordingly, when the inner ring 420 is rotated, the first, second, and third engagement tools 431a, 432a, and 433a sequentially apply engagement force to the outer ring saw teeth 412. As a result, the multi-angle bundle pawl unit 430 is constantly engaged with the outer ring saw teeth 412 in a sequential manner.

That is, in the backstop ratchet ring 401, segmented engagement sections of the engagement tool saw teeth 431b, 432b, and 433b are provided within one pitch of the outer ring saw teeth 412. Accordingly, even if slight rotation occurs, engagement force is achieved at sequential positions respectively having different angles in a sequential manner. As a result, when reverse power is transmitted, precise power transmission may be performed without backlash occurrence.

Meanwhile, in the automatic direction switching pendulum-type rotary drive ratchet for the indirect live wire 1 according to the present invention, when a worker wants to fully tighten the belt during work preparation time before using the gear grip 20 or the tensioner 30, it is possible to simply manually rotate the pendulum drive shaft 300 in the reverse direction without operating the rotary operating lever 200. Rotation of the pendulum drive shaft 300 in the reverse direction may be possible by controlling rotation of the pendulum drive shaft rotary lever 1000 connected to the pendulum drive shaft 300 in a state in which the rotation control lever 440 is separated from the stopping groove 413 of the outer ring 410.

As described above, in the automatic direction switching pendulum-type rotary drive ratchet for the indirect live wire according to the present invention, even if a separate direction switching device is not operated to rotate the pendulum drive shaft in the forward or reverse direction, reversal operation of the pendulum drive shaft may be automatically performed by adjusting the rotation direction of the rotary operating shaft and operating the pendulum. In particular, when the pendulum drive shaft is driven in the forward direction in which tension of the gear grip or the tensioner acts, reverse rotation of the pendulum drive shaft is completed prevented by operation of the backstop ratchet ring, thereby making it possible to perform stable operation thereof.

### INDUSTRIAL APPLICABILITY

As is apparent from the above description, the present invention provides an automatic direction switching pendulum-type rotary drive ratchet for an indirect live wire, configured to automatically perform forward or reverse rotation of a pendulum drive shaft operating plate through reciprocating motion of a pendulum in accordance with rotation direction adjustment of a rotary operating shaft, thereby making it possible to automatically perform forward rotation or reverse rotation of a pendulum drive shaft by simply conducting indirect live wire work without performing a separate rotation direction switching operation. Additionally, a backstop ratchet ring is capable of preventing reverse rotation of the pendulum drive shaft, preventing backlash occurrence when the pendulum drive shaft is driven in the reverse direction, and constantly performing bidirectional rotation in a reliable manner, thereby having an effect of securing stability of a device.

1. An automatic direction switching pendulum-type rotary drive ratchet for an indirect live wire, the automatic direction switching pendulum-type rotary drive ratchet comprising:
a body (100) having a lever installation part (110) formed on one side thereof;
a rotary operating lever (200) comprising a rotary operating shaft (210), a cam (220), a rotary operating mechanism (230), and a buffer key (200), wherein the rotary operating shaft (210) is axially installed in the lever installation part (110) and has a rotating ring (211), wherein the cam (220) is disposed at a tip portion of the rotary operating shaft (210) and is formed at a location eccentric from a central portion of the tip portion, wherein the rotary operating mechanism (230) is rotatably coupled to the rotary operating shaft (210) at a rear side of the cam (220), has a movable long hole (231) formed in a circumferential direction thereof, and has a locking protrusion (232) formed to protrude from a circumference thereof, wherein the buffer key (240) connects the rotary operating shaft (210) to the rotary operating mechanism (230);
a pendulum drive shaft (300) axially installed in the body (100) from the other side of the body (100) and formed to penetrate the body (100) in a forward-and-rearward direction of the body (100);
a clutch part (400) disposed on a front side of the body (100) and coupled to a periphery of the pendulum drive shaft (300), wherein the clutch part (400) prevents reverse rotation of an inner ring and operates forward or reverse rotation of the pendulum drive shaft (300) through simultaneous reverse rotation of the inner ring and an outer ring;
a pendulum drive shaft operating plate (500) disposed on a front side of the clutch part (400) and coupled to the periphery of the pendulum drive shaft (300), wherein the pendulum drive shaft operating plate (500) has saw teeth (510) formed around a middle portion thereof;
a pendulum (600) coupled to a rear side of the pendulum drive shaft operating plate (500) and formed to protrude toward one side thereof so as to have a horizontal long hole (610) configured to accommodate the cam (220) therein, wherein the pendulum (600) performs reciprocating pendulum motion relative to the pendulum drive shaft (300) by operation of the cam (220) and has an automatic revering pawl mounting groove (620) formed in a front surface thereof and disposed between the rotary operating shaft (210) and the pendulum drive shaft operating plate (500);
a support plate (700) formed to penetrate a front circumference of the pendulum drive shaft operating plate (500) and coupled to the pendulum (600), wherein the support plate (700) is formed to protrude toward one side thereof;
an automatic reversing pawl (800) having a pawl shaft (801) coupled to the automatic revering pawl mounting groove (620), wherein the automatic reversing pawl (800) interferes with the pendulum drive shaft operating plate (500) and operates in reciprocating motion so as to provide forward or reverse rotational force of the pendulum drive shaft operating plate (500);
a pawl reversing key (900) coupled to the pawl shaft (801) with the automatic reversing pawl (800) and formed to protrude from the support plate (700) toward one side thereof, wherein the pawl reversing key (900) interferes with the locking protrusion (232) during rotation of the rotary operating mechanism (230) so as to provide reciprocating rotational force of the automatic reversing pawl (800), and wherein the pawl reversing key (900) has first and second reversing key spring balls (910) and (910′) installed thereon so as to constantly maintain horizontality thereof, wherein the first and second reversing key spring balls (910) and (910′) are formed to be symmetrical relative to the pawl shaft (801); and
a pendulum drive shaft rotary lever (1000) disposed on a front side of the pendulum drive shaft operating plate (500) and coupled to the pendulum drive shaft (300) and the pendulum drive shaft operating plate (500).

2. The automatic direction switching pendulum-type rotary drive ratchet according to claim 1, wherein:
the buffer key (240) has one side fixed to the rotary operating shaft (210) and the other side located in the movable long hole (231) of the rotary operating mechanism (230),
the buffer key (240) is configured to perform, when rotating the rotary operating shaft (210) in a forward or reverse direction, idle rotation for a predetermined period of time within the movable long hole (231), and
the buffer key (240) is configured to rotate, when caught at one end of the movable long hole (231), the rotary operating mechanism (230).

3. The automatic direction switching pendulum-type rotary drive ratchet according to claim 1, wherein:
the clutch part (400) is formed as a backstop ratchet ring (401),
the backstop ratchet ring (401) comprises:
an outer ring (410) having an inner ring mounting hole (411) formed to penetrate a central portion thereof, wherein the inner ring mounting hole (411) has outer ring saw teeth (412) formed on an inner peripheral surface thereof, wherein the outer ring saw teeth (412) have straight portions and inclined portions continuously formed in a circumferential direction, wherein the outer ring (410) has stopping grooves (413) formed on an outer circumference thereof and disposed at regular intervals;
a circular ring-shaped inner ring (420) having a shaft hole (421) formed to penetrate a central portion thereof and configured to allow the pendulum drive shaft (300) to be coupled thereto, wherein the inner ring (420) is mounted in the inner ring mounting hole (411) of the outer ring (410) and has a plurality of bundle pawl mounting grooves (422) formed on a circumference thereof and disposed at regular intervals;
a multi-angle bundle pawl unit (430) having springs (S) each installed in a corresponding one of the bundle pawl mounting grooves (422), wherein the multi-angle bundle pawl unit (430) is operated to protrude outwards by spring elasticity of the spring (S) and is engaged with the outer ring saw teeth (412) of the outer ring (410) so as to provide rotational force in one direction; and
a rotary control lever (440) formed on the body (100) and configured to interfere with a corresponding one of the stopping grooves (413) of the outer ring (410) or to be released therefrom so as to control rotation and stoppage of the outer ring (410), and
the multi-angle bundle pawl unit (430) is formed of plural groups of first, second, and third multi-angle bundle pawls (431), (432), and (433), wherein the respective first, second, and third multi-angle bundle pawls (431), (432), and (433) are configured to be engaged with the outer ring saw teeth (412) of the outer ring (410) at sequential positions respectively having different angles.

4. The automatic direction switching pendulum-type rotary drive ratchet according to claim 3, wherein:
the outer ring saw teeth (412) of the outer ring (410) are formed to protrude inwards so as to have front and rear stepped portions (412a) and (412b) respectively formed at a front side of the outer ring saw teeth (412) and a rear side thereof,
the inner ring (420) has a seating protrusion (423) and a finishing plate support portion (424), wherein the seating protrusion (423) is formed on a rear circumference of the inner ring (420) and is seated on the rear stepped portion (412b) of the outer ring (410), wherein the finishing plate support portion (424) is formed to protrude from a front side of the inner ring (420) so as to extend from the shaft hole (421), and
the finishing plate support portion (424) formed on the front side of the inner ring (420) penetrates a finishing plate (425) having a through hole (425a) formed therein, wherein the finishing plate (425) is seated on and coupled to the front stepped portion (412a) so as to constrain the outer ring (410).

5. The automatic direction switching pendulum-type rotary drive ratchet according to claim 3, wherein:
the first, second, and third multi-angle bundle pawls (431), (432), and (433) are configured to form three groups, wherein each of the three groups is formed of a corresponding one of first, second, and third engagement tools (431a), (432a), and (433a), wherein each of the radially arranged four first engagement tools (431a), four second engagement tools (432a), and four third engagement tools (433a) forms one group,
each of the first, second, and third engagement tools (431a), (432a), and (433a) has a corresponding one of the springs (S) respectively installed in the bundle pawl mounting grooves (422) so as to have protruding force, wherein the first, second, and third engagement tools (431a), (432a), and (433a) are positioned to intersect each other, and the first, second, and third engagement tools (431a), (432a), and (433a) have engagement tool saw teeth (431b), (432b), and (433b) respectively formed at tip portions thereof, wherein each of the engagement tool saw teeth (431b), (432b), and (433b) has straight portions and inclined portions formed to be engaged with the outer ring saw teeth (412) of the outer ring (410), and
when the inner ring (420) is rotated in one direction, the engagement tool saw teeth (431b), (432b), and (433b) of the first, second, and third multi-angle bundle pawls (431), (432), and (433) do not interfere with the outer ring saw teeth (412), thereby enabling idling rotation of the inner ring (420), and when the inner ring (420) is rotated in the other direction, the engagement tool saw teeth (431b), (432b), and (433b) of the first, second, and third multi-angle bundle pawls (431), (432), and (433) are sequentially engaged with the outer ring saw teeth (412), thereby preventing the reverse rotation of the inner ring (420).

6. The automatic direction switching pendulum-type rotary drive ratchet according to claim 1, wherein:
the automatic reversing pawl (800) has a pair of first and second locking protrusions (810) and (810′) formed on one side thereof and configured to be selectively engaged with the saw teeth (510) of the pendulum drive shaft operating plate (500),
the automatic reversing pawl (800) has first locking grooves (821) and (821′) and second locking grooves (822) and (822′) provided around a circumference thereof and formed to be symmetrical with each other,
the automatic reversing pawl (800) has a tapered revering key mounting groove (830) provided at a central portion thereof and formed to extend from the pendulum drive shaft operating plate (500) to the rotary operating shaft 210, wherein the revering key mounting groove (830) is configured to allow the pawl revering key (900) to be coupled to the pawl shaft (801) with the automatic reversing pawl (800),
the pendulum (600) has first and second reversing pawl spring balls (840) and (840′) elastically installed therein and configured to control a reciprocating rotation direction of the automatic reversing pawl (800), and
the first reversing pawl spring ball (840) is configured to be caught in any one of the first locking grooves (821) and (821′) so as to intersect the any one of the first locking grooves (821) and (821′), and the second reversing pawl spring ball (840′) is configured to be caught in any one of the second locking grooves (822) and (822′) so as to intersect the any one of the second locking grooves (822) and (822′).
